(19) United States
(12) Patent Application Publication
(10) Pub. No.: US 2008/0096645 A1
(43) Pub. Date: Apr. 24, 2008

(54) SYSTEM AND METHOD FOR SLOT SYSTEM WAGERING

(76) Inventors: Gary Frerking, Henderson, NV (US); Stephen Byng, Cherrybrook (AU)

Correspondence Address: MCANDREWS HELD & MALLOY, LTD, 500 WEST MADISON STREET, SUITE 3400, CHICAGO, IL, 60661, US

(21) Appl. No.: 11/552,404

(22) Filed: Oct. 24, 2006

(51) Int. Cl. A63F 9/24; A63F 13/12

(52) U.S. Cl. 463/25

(57) ABSTRACT

Certain embodiments provide systems and methods for slot system and other dependent wagering. Certain embodiments include allowing a player to place a wager, wherein the wager is related to performance of a gaming system, monitoring performance of the gaming system, and awarding a prize based on the wager upon occurrence of a proposition related to performance of the gaming system. Certain embodiments include an interface converting an input of a wager into a wager record, wherein input of the wager includes selecting at least one event and selecting a relationship for the at least one event to form a proposition, an event monitor configured to monitor events occurring in one or more gaming terminals, wherein the event monitor identifies an event relating to the wager record, and an event handler configured to examine the wager record and the identified event to determine if the proposition is satisfied.

### BACKGROUND OF THE INVENTION

This invention relates to increased wagering opportunities, and more particularly relates to systems and methods for slot system and other dependent wagering.

Gaming machines, such as slot machines, fruit machines, or poker machines, offer popular, exciting, and sophisticated wagering activities at casinos and other gambling locations. At the same time, gaming machines have also become a source of greater revenue for gaming establishments. Thus, competition between manufacturers of gaming machines has intensified as competitors vie for business from gaming establishments. Gaming machine manufacturers and gaming establishments continually seek new ways to attract patrons, provide entertainment and generate revenue through gaming opportunities. Thus, a gaming system providing entertaining and enticing features for players would be highly desirable to attract both new and returning players to a gaming establishment.

Gaming wagers are typically made in relation to an outcome of a particular play or event. In current slot machine gaming systems, for example, a standard bet per line is defined and resolved within the course of one game play. That is, a winner and/or a loser are determined in one game play, and the outcome hinges on the outcome of the game during that game play. Bets per way are similarly defined and resolved within the course of one game play. Bets on a sporting event are resolved by the outcome of that sporting event. Casinos and other establishments may be able to capitalize on other wagering opportunities outside of traditional bets. Thus, a system and method for providing alternative wagering opportunities would be highly desirable.

### BRIEF SUMMARY OF THE INVENTION

Certain embodiments provide systems and methods for slot system and other dependent wagering. Certain embodiments provide a method for system wagering, which includes allowing a player to place a wager, wherein the wager is related to performance of a gaming system. The method also includes monitoring performance of the gaming system, and awarding a prize based on the wager upon occurrence of an event related to performance of the gaming system.

Certain embodiments provide a dependent wagering system. The system includes an interface converting an input of a wager into a wager record, wherein input of the wager includes selecting at least one proposition related to one or more events which may (or may not) occur in relation to the play at the gaming devices of the system. The system also includes an event monitor configured to monitor events occurring at one or more gaming devices, wherein the event monitor identifies an event relating to the proposition. The system further includes an event handler configured to determine when and if the wagered upon proposition occurs.

Propositions may include that a certain event will or will not occur. For example, a proposition may include that a jackpot of $1000 will occur at a particular slot machine or bank of slot machines within the next 24 hours, that a jackpot of at least $1000 will not occur at a particular slot machine in the next 24 hours, that a bad beat jackpot will be awarded in Poker in the next 5 days, that a particular machine or bank of video Poker machines will have a Royal Flush result in the next 48 hours, or the like. It should be understood that other propositions could be established as well. Each defined proposition has associated therewith several parameters such as: minimum and maximum wager which can be made on the proposition, the terms of the proposition and the odds associated with the proposition.

Certain embodiments of the present invention provide a machine-readable medium including a set of instructions capable of execution by a processing device. The set of instructions includes a wager configuration routine for constructing a wager based on one or more selected propositions, a monitoring routine for monitoring events occurring in a gaming environment for determination as to whether the conditions of the propositions wagered upon have been fulfilled or have failed, and a technique for notifying or providing information to the players if their wager has been won or lost and awarding any winnings to the players.

### BRIEF DESCRIPTION OF THE DRAWINGS

FIG. 1 illustrates a casino network system used in accordance with an embodiment of the present invention.

FIG. 2 depicts a flow diagram for a method for slot system wagering used in accordance with an embodiment of the present invention.

FIG. 3 shows a flow diagram for a method for event handling for slot system wagering used in accordance with an embodiment of the present invention.

FIG. 4 illustrates a system for placing and monitoring system wagers in accordance with an embodiment of the present invention.

FIGS. 5a-5h illustrate a plurality of exemplary interfaces and menus for slot system wagering used in accordance with embodiments of the present invention.

FIG. 6 depicts a system for recording slot system wagers in accordance with an embodiment of the present invention.

FIG. 7 illustrates an example of a slot system wagering scrip in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

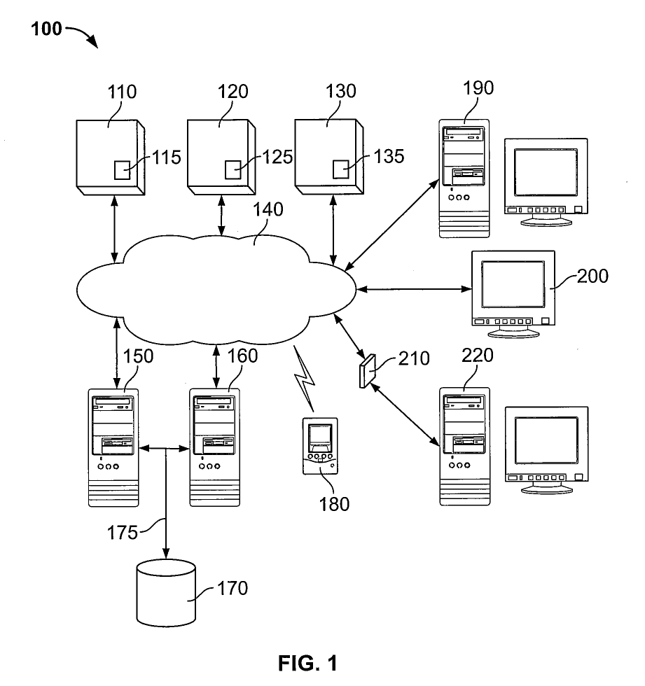

FIG. 1 illustrates a casino network system 100 used in accordance with an embodiment of the present invention. The casino network system 100 includes a plurality of gaming terminals 110, 120, and 130 interconnected through network 140 to a slot accounting and/or player tracking system 150 (hereinafter collectively referring to as a player tracking system 150), and slot system wagering manager 160. The network 140 may include one or more networks and/or subnetworks occupying various media, for example.

It should be understood that, while the present description refers to gaming terminals as “slot machines”, that video gaming machines and gaming tables such as Blackjack, Pai Gow, Baccarat and others may be subject to slot system wagering and/or other configuration where such tables are so adapted. Adaptation of tables may include apparatus to detect gaming system proposition-related events such as Blackjack or Pai Gow table outcomes and the like. The apparatus may include card readers or scanners or may simply entail the dealer inputting the relevant data. Thus gaming terminal as used herein includes slot machines, video poker and Keno machines, video or electromechanical roulette machines, gaming tables, and other gaming devices.

Gaming terminals and/or other gaming devices may be located in a local gaming environment, such as a casino, and/or a multi-site gaming environment, such as a plurality of networked casinos. Gaming terminals may also be located in non-traditional gaming environments, such as restaurants, stores, and/or airports. Gaming terminals may be used to play a first game and/or multiple games employing one or more rewards.

Player tracking system 150 and slot system wagering manager 160 are connected to database server 170 via a communication link 175, which may be integrated with or separate from network 140. Database server 170 may consist of one or more independent servers which may or may not be in communication with each other, depending upon a particular implementation. In an embodiment, the casino network system 100 may be implemented in another gaming environment, such as a hotel, restaurant, theater, store, airport or other venue having one or more gaming systems.

System 100 also includes a system workstation 190, connected to network 140. In addition, one or more self-service kiosks 200, one or more wireless devices 180, and/or one or more external systems 220 may be connected to network 140. External system 220 is connected to network 140 through optional firewall 210, and may include a workstation in a hotel room, remote casino, and/or other location external to the casino, for example.

One or more kiosks 200 may be used to facilitate operations such as gaming, slot ticket redemption, player card point redemption, change and/or currency dispensation, promotion redemption and/or issuance, advertising, information, event and/or dining reservations and/or ticketing, etc. For example, one or more kiosks 200 and/or external systems 220 may used to purchase and/or view sports scores, news, game announcements, weather, flight information, show times, specials, reward tickets, prize tickets, coupons, airline or show tickets, reservation confirmation, or other information, for example. Additionally a player may be able to locate his or her favorite games, restaurants or other facilities and/or services at a kiosk 200. The kiosk 200 may also provide a venue for players to make wagers on gaming system propositions according to certain embodiments of the present invention.

In certain embodiments, wireless device 180, such as a cellular phone, personal digital assistant, handheld or pocket computer, etc., may be used to interact with systems in a gaming environment. For example, the wireless device 180 may be used to retrieve game and/or sports scores, reservation information, weather information, travel information, entertainment information, etc. The wireless device 180 may also be used to place bets, make reservations, redeem rewards/prizes, etc.

Gaming terminals 110, 120, and 130 include smart communications interfaces (SCI) 115, 125, and 135 respectively, which communicate with network 140. In other embodiments, SCI 115, 125, and 135 may instead and/or in addition communicate with player tracking system 150 via other system and/or method, such as a serial communications protocol. In an embodiment, SCI 115, 125, and 135 may be integrated into a game controller for gaming terminals 110, 120, and 130.

A display associated or integrated with the gaming terminals 110, 120, 130 displays primary game features for play of a game. For example, for a play of a conventional stepper-type slot machine, the player makes a wager and initiates play whereupon reels are rotated to display a wilming or losing game outcome. A video slot machine controls a display to display the outcome. The gaming terminals 110, 120, 130 and/or a bank of gaming terminals 110, 120, 130 may also include a secondary or other additional display. The additional display may display player information, secondary game information, system wagering information, supplemental information, promotional information, etc. Alternatively, additional information may be displayed via the primary display and/or other output, for example.

In certain embodiments, a system wager made by a player is for the next or other subsequent play of the game. Once that play (along with any provided bonus features, is completed, the player may make another wager for the next play or “spin” of the game.

Player tracking system 150 collects data from SCI 115, 125, and 135 for purposes of slot accounting, monitoring and security, and player tracking. Player tracking system 150 processes and stores data in database 170 and/or other local and/or remote data store. Player tracking system 150 may be configured to track data such as player activity, player win, casino or other gaming establishment activity, etc. The slot accounting feature may track coin-in, wins, jackpots, overall machine performance, etc., as well as security events such as opening of a machine for service, and/or the like. Thus, the player tracking system 150 provides data from the gaming terminals as to jackpots or other wager-performance data. As but an example, when a slot machine hits its major jackpot, the player tracking system 150 receives data related to that event.

In certain embodiments, the player tracking system 150 may be used to determine player profiles. This profile information may include favorite games of a player, player configuration options, his/her typical wager, gaming session time, time of day when the player plays, the player's win and the like. Player profile information may be used to suggest, offer, include and/or exclude players from certain propositions, for example. Player profile information may be used by the slot system wagering manager 160 to configure one or more wagering propositions and/or suggest one or more propositions for a gaming terminal 110, 120, 130 at which a particular player is playing, for example. Additionally, the system 100 may suggest slot system wager propositions to a player based on factors such as historical data, wager rating, wager availability, player preference, player ranking, player access, player credit, newest wagers, most popular wagers based on statistical tracking of game play, most popular wagers based on customer ratings and reviews, events in the vicinity of the gaming terminal, etc.

Slot system wagering manager 160 receives information relevant to slot system wagering from player tracking system 150 and database 170. For example, slot system wagering manager 160 may include an interface to player tracking system 150 to facilitate transfer of information between manager 160 and tracking system 150 via a compatible protocol such as the S2S (System-to-System) standard defined by the Gaming Standards Association™ (GSA). In an embodiment, slot system wagering manager 160 receives information from a database separate from database 170 used by player tracking system 150. In an embodiment, slot system wagering manager 160 may receive slot system wagering information independent of player tracking system 150. Slot system wagering manager 160 also may receive information directly from gaming terminal 110, 120, 130. Gaming terminals 110, 120, 130 may be connected to slot system wagering manager 160 and/or player tracking system 150 via separate networks or a common network, such as an Ethernet network, wireless network, and/or other network.

Slot system wagering manager 160 allows bets to be placed on propositions related to events in addition to and/or outside of traditional gaming outcomes, for example. Additional or side bets, for example, may be placed and processed via the slot system wagering manager 160. Slot system wagering manager 160 processes information to determine/set variable odds as appropriate for available slot system wagers. SCI 115, 125, and 135, wireless device 180, system workstation 190, kiosk 200, and/or external system 220 may receive available wager and related information, such as variable spreads and/or variable odds, from slot system wagering manager 160. As but an example, there may be a particular bank of 10 slot machines which are substantially the same and which each offer a top jackpot prize of $1000. The slot wagering manager 160 or an operator, based upon the frequency of play at this bank of slot machines, may decide to offer the following system wagering proposition to any player:

1. A major jackpot will occur at this slot machine bank within a designated 24 hour period.

2. A major jackpot will NOT occur at this slot machine bank within a designated 24 hour period.

In the above example, based upon the statistical data, the operator has determined that this bank of machines usually hits 2 jackpots in a 24 hour period. Therefore he sets the odds as follows: for Proposition #1-230 (which means that to win $1 the player must risk $2.30 and for Proposition #2-50 (which means to win $1 the player must wager $0.50.). The odds may remain fixed or may vary based on, for example, a pari-mutuel basis where odds are changed to induce players to one side or the other of the proposition so no one side is overloaded creating a big exposure should that proposition be fulfilled.

Slot system wagering manager 160 may be configured by casino and/or other appropriate personnel to establish a set of system wagers supported by the system 100. The set of system wagers may be influenced by jurisdictional requirements, system and/or individual gaming machine capabilities, and/or other criteria determined by a gaming property, regulatory entity, manager, etc.

To place a slot system wager, a casino patron and/or casino employee (as appropriate) accesses a slot system wagering menu at gaming terminal 110, 120, and/or 130, SCI 115, 125, and/or 135, wireless device 180, system workstation 190, kiosk 200, and/or external system 220, for example. The player, such as the casino patron or employee, selects from a list or other presentation of available proposition wagers. In certain embodiments, an interface is presented to the player and/or other user in the form of a menu or other listing of options, one or more buttons, a touchscreen or touchpad with options, etc. Wagers may be presented in the form of a fixed bet, a series of options, and/or a user-definable bet (e.g., a wager defined within certain parameters set by the system and/or subject to approval by authorized personnel and/or automated system). The player then pays via any available method at the wagering device (e.g., gaming machine 110, 120, and/or 130, wireless device 180, system workstation 190, kiosk 200, and/or external system 220). Slot system wagering manager 160 queues the wager in database 170, for example. In an embodiment, a printed and/or electronic receipt may be generated for the transaction.

Slot system wagering manager 160 periodically reviews the wager queue to determine whether any of the active propositions have been fulfilled or have failed and thus whether wagers may be paid and/or collected. This review may also, as discussed above and based upon the wagers received, adjust the proposition odds. Alternatively, wager queue review may be interrupt and/or event driven (e.g., a jackpot hit, a certain time, a gaming machine win, etc.) to trigger the slot system wagering manager 160 to review wagers in the wager queue, for example. When a terminating condition (e.g., a loss) is detected, the terminated wager record is moved from the active wager queue or table to an archive table in the database 170, for example. When a win is detected, the player may be notified, and an award may be printed or otherwise transmitted, paid (e.g., electronic and/or hand pay), and/or credited to an account, such as a player account with a gaming property or a bank, for example. Proposition outcomes may be posted at an Internet site, for example, to allow players to access remotely and determine if they have won or lost. If the player does not have a player account, the win may be recorded in a “will call” win table, for example. The wager record is then archived. Unclaimed wins may expire after a period of time, depending upon property preferences and jurisdictional requirements.

It should be noted that unlike “futures” wagering which can take the form of sports wagers, e.g. the Chicago Bears to win the Super Bowl next season, or horse racing such as “Pick 6” wagers (pick the winners of 6 races), where the player or wagering on the outcome of a future event in a sporting event, certain embodiments of the present invention are directed in at least one respect to wagering on an outcome or several outcomes or a chain of events occurring in a network of electronic games which have no set schedule of play (like a horse race going off), may or may not be played at all, may be subject to varying skill levels of players such as in skill or semi-skilled games (Blackjack, video Poker) and where terminals are played individually and primarily to produce individual results (the individual players may not care or may oblivious to a system wager involving their terminal).

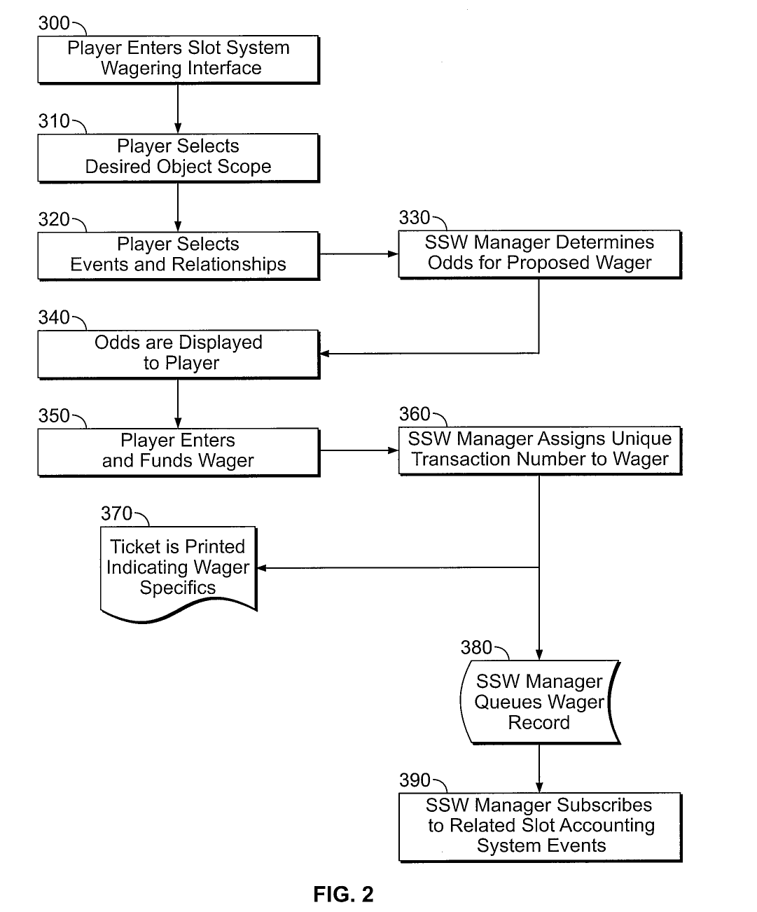

FIG. 2 depicts a flow diagram for a method for slot system wagering used in accordance with an embodiment of the present invention. At step 300, in order to place a slot system wager, a player enters a slot system wagering interface or other interface at an appropriate location, such as the SCI of a gaming terminal or other similar gaming machine, a kiosk, a wireless portable interface, and/or an external computer via an Internet connection or other connection. In certain embodiments, a casino employee or other personnel may operate a slot system wagering interface for the player.

At step 310, the player selects and/or otherwise defines a desired scope of wager using the slot system wagering interface. In certain embodiments, a player and/or other user may select and/or define a wager at the time of the bet and/or may configure one or more wagers ahead of time and later place the bet. The player may select from various categories of propositions offered, e.g. slot machine bank propositions (such as a jackpot will or will not occur in a given time frame), individual machine propositions (such as this machine will produce a Royal Flush in the next stated time period), system wide wagering (such as no jackpot in excess of $20,000 will be won in the system in the next 24 hours), multi-site propositions (no jackpot of over $100,000 will be awarded at any linked property in the next 20 days) or the like. At step 320, the player selects and/or otherwise defines events and/or propositions characterizing the wager from a set of offered propositions. In certain embodiments, the player is only presented with options that would construct valid wagers. In certain embodiments, the player is allowed to create a new proposition and request approval to place a bet with respect to that proposition with certain odds. Once the wager is defined, a slot system wagering manager and/or other system determines odds, at step 330, for the proposed wager. At step 340, the odds are displayed and/or otherwise presented to the player.

In certain embodiments, odds for one or more wagers and/or potential wagers may be calculated in advance and/or dynamically by an electronic system and/or authorized personnel. Odds may be calculated on a historical basis, for example. Historical data may be tracked and analyzed to determine reasonable odds for a wager and/or group of wagers. Odds may vary based on bet, for example. Odds may be mathematically calculated based on known odds of a gaming machine and/or group of gaming machines and/or mathematically calculated based on historical statistics and/or other related data, for example. As stated above, odds may vary in a fashion to induce wagers on one side of the proposition or another much like sports wagering in Nevada sports wager booking establishments.

At step 350, the player completes the wager transaction by accepting the proposed odds and funding the wager by any system and/or method available to the player. In certain embodiments, the wager may be funded in a variety of ways including cash, voucher, ticket, credit card, and/or other payment vehicle, for example. The player may also pay from an online player's account, such as a Personal Banker® account, or other account, from credits on the player's gaming machine or other device, and/or from other funded and/or credit account, for example. An example of a player account is found in U.S. Pat. No. 6,511,377, which is herein incorporated by reference in its entirety. In certain embodiments, a player may fund a slot system wager with promotional credits, loyalty points, and the like. A slot system wager may be made directly (e.g., after a period of time, a predetermined slot system wager is awarded to the player) or indirectly (the player may apply accrued loyalty points towards the purchase of a slot system wager). The player may also enter, if the system so provides, an email address or other contact information for notification to the player on a remote basis, for example.

At step 360, a wager record is created in response to the player placing a wager, and a transaction number, such as a unique or reusable identification number, is assigned to the wager record. At step 370, a ticket and/or other verification may be printed and/or otherwise generated to serve as a record for the transaction. At step 380, the wager record is stored, such as in a slot system wagering database and/or other database. At step 390, system events related to the wager are monitored. For example, a slot system wagering manager notifies a slot accounting system and/or tracking system of its interest in events related to the wager, such as by subscribing to related slot accounting system events.

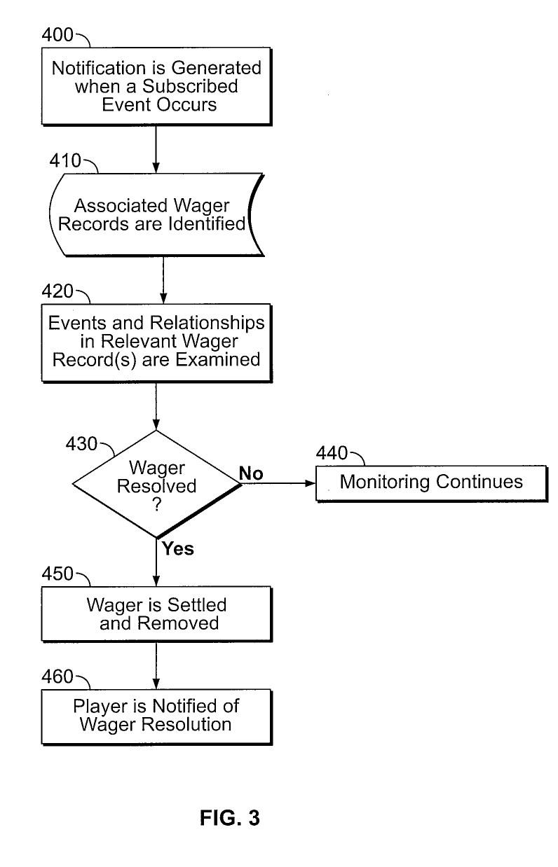

FIG. 3 shows a flow diagram for a method for event handling for slot system wagering used in accordance with an embodiment of the present invention. At step 400, when a subscribed event occurs (proposition is fulfilled), a notification is generated. For example, the slot accounting system, such as an OASIS™ system, SAS system, and/or add-on monitoring system, sends a notification to the slot system wagering manager. At step 410, wager records associated with the proposition are identified. For example, the slot system wagering manager queries a database to identify all wager records associated with the event related proposition(s).

At step 420, event(s) and relationship(s) forming a proposition in each relevant wager record are examined, and, at step 430, it is determined whether the incoming event resolved any of the wagers. For example, the slot system wagering manager or other system inspects the events and relationships in each wager identified wager record to determine if the incoming events resolved any of the wagers. If the event did not resolve any wagers, at step 440, monitoring continues. For example, the slot system wagering manager or other system performs any necessary cleanup and exits an event handler to continue monitoring events and/or receiving event updates. If a wager has been resolved, then at step 450, the wager is settled and removed. For example, the slot system wagering manager or other system may update the database regarding resolution of the wager. If the wager results in a loss for the player, the “house” is paid, and, if the wager results in a win for the player, the player is paid. At step 460, if an appropriate system and/or method are available, the player is notified of the resolution of the wager. For propositions which are time based, the system clock monitors elapsed time and, once the stated time has elapsed, all wagers related to the proposition are reconciled.

Slot accounting and player tracking systems, such as an Aristocrat® OASIS™ system, an IGT® SAS system and/or a separate add-on monitoring system, interface with gaming terminals in a gaming property to track statistics related to play on the gaming terminals, notify personnel of system events, such as large jackpots, and/or track play of players that have enrolled in a loyalty program, for example. In certain embodiments, statistics and/or notifications may serve as a basis for additional betting opportunities at a system level. Certain embodiments leverage existing gaming system hardware and/or software to offer a wide array of betting opportunities (referred to as system wagers, slot system wagers, delayed dependent wagers, dependent wagers, and/or delayed wagers, for example) to players. Certain embodiments may provide increased and alternative betting opportunities with little or no increase in staffing or floor space in a gaming property, for example.

System wagers and other related betting opportunities may be resolved during one gaming play or may be contingent upon one or more events driven by game play and/or occurring during multiple game plays, for example. In certain embodiments, players define two or more events, for example, and define a condition linking the events together. The system calculates probabilities and offers appropriate player incentive based on a theoretical return to the player. Alternatively, a gaming system and/or personnel may define event(s) and condition(s), as well as associated probabilities and awards for selection by a player.

System wagers may be constructed by defining a scope of the wager, one or more events determining a winning condition for the wager and a terminating condition for the wager, and relationship(s) between the event(s) and/or wager scope(s), for example. One or more events and one or more relationships define, for example, a proposition for the wager. Examples of wager scope may include current slot machine, adjacent slot machine (e.g., to the right and/or left of the current slot machine), current slot bank; slot bank by name, entire slot floor, current player, individual player by name and/or number, and/or player group by name, age, sex, and/or other classification (e.g., “carded”, “uncarded”, “gold level”, etc.). Examples of win and/or terminating events may include gaming terminal win event(s), win type(s), win value(s), win range(s), time period, time of day, number of games played, and/or number of winning games. Examples of dependencies and/or other relationships between events and/or wager scopes may include an event/wager occurring before and/or after another event/wager, an event/wager greater than and/or less than another event/wager, and/or an event/wager coinciding with another event/wager.

Slot system wagers may then be constructed using scope, event and dependency elements. Elements may be generated and/or selected from a list to form a wager. For example, a system wager may include: [Slot Machine A][pays a $100+ win][before][Slot Machine B]. As another example, a wager may be: [10:00 PM 12 Dec. 2005][occurs before][Slot Machine A][pays a $50+ win]. Other examples may include: [Slot Bank A][pays a $1000+ win][before][Slot Bank B]; [Slot Machine A][pays 10 $100+ wins][before][2000 games played]; [[Slot A] and [Slot B] and [Slot C]][pay $100 wins][before][10:00 PM 12 Dec. 2005]; [[Slot A] or [Slot B] or [Slot C]][pay $100 win][before][10:00 PM 12 Dec. 2005]; and/or [Player A][receives a $100+ win][before][Player B].

In certain embodiments, an operator and/or other authorized personnel may configure slot system wagers. In certain embodiments, a player and/or registered player or other user may configure slot system wagers. A user interface, for example, may be used to facilitate development of system wagers. In certain embodiments, a menu or listing of pre-configured and/or popular wagers may be provided for selection. In an embodiment, a player may store “favorite” wagers, such as in a player tracking account.

A slot system wager may be placed on random events and/or performance of a single gaming terminal. For example, a player plays at a given slot machine for a period of time. Before leaving the machine, the player accesses a slot system wagering menu on the machine's player tracking system interface and places a bet against the machine the player is leaving. For example, the player bets that the slot machine will not pay a jackpot exceeding $100 in the next 24 hours. As another example, a player plays at a given slot machine and leaves for an appointment. Before leaving, the player places a bet on the slot machine, such as a bet that the slot machine will pay a jackpot exceeding $250 in the next two hours. Additionally, for example, a player may note that an adjacent slot machine is performing well (e.g., is “hot”) and places a wager on the adjacent machine such that the slot machine to the right of the player's machine will pay a jackpot exceeding $100 within the next hour.

When a slot system wager is made at a gaming terminal or other gaming device, payment for the wager may be made via any method available a the gaming terminal, such as transferring from the gaming terminal's credit meter, coin in, bill in, voucher in, promotional coupon in, and/or from a system account, such as a PersonalBanker account or player loyalty/rewards account. A receipt may then be generated for the bet showing the wager made along with a timestamp, parameters related to the bet, and an identifier associating the receipt with the wager in a database or other record.

Winnings from system wagers may be paid directly to a player's account (e.g., a personal banker account, casino account, bank account, credit card account, player loyalty account, etc.). Alternatively, winning may be stored in a system database and hand paid by personnel upon surrender or presentation of the associated wager receipt. If the player is actively playing at a gaming terminal when a win occurs, the player may be notified of the win via that machine's player tracking system interface, a secondary display, and/or a message on a primary machine display, for example. A player may also be notified via a gaming floor notification, a wireless device, text page, email, in person by personnel, and/or other message, for example.

System wagers may be placed on random events and/or performance of multiple gaming terminals. For example, a casino patron may note a popular bank of gaming machines, access a player account at a kiosk, and select a slot system wagering menu. The player identifies the slot machine bank by a suitable method, such as by name, or by identifying a location of the bank on a map of the casino floor. The player then places a bet that the chosen bank of slot machines will outperform a house average. In an embodiment, the bet may be contingent on a certain “spread” (e.g., the bank of slots will outperform the house average by 200% over the next 24 hours). A spread or odds may be computed by a system and/or personnel based on historical performance of related machines and applied to available bets, for example. Similarly, for example, a patron may contact an employee and place a bet that a jackpot exceeding $1000 will occur at a particular bank of slot machines within the next five hours. As another example, gaming terminals may be divided in alternate or additional ways (e.g., a jackpot exceeding $1000 will occur in the northern half of the slot floor within the next two hours or odd numbered slot machines will outperform even numbered slot machines by 5% over the next hour, or Aristocrat® slot machines will outperform IGT® slot machines by a per machine average of 50% over the next two hours).

System wagers may be made in relation to multiple locations and/or properties, for example. As an example, a patron may wager that the next jackpot exceeding $1000 will occur at Property A. For example, a patron may wager that slot machines at Property B will outperform slot machines at Property A by 10% over the next week.

Wagers may also be made on wide area progressive events. For example, a player may bet that the next MegaBucks® jackpot will occur on a particular machine, in a bank of machines, and/or in a particular casino or other gaming property. For wide area progressives, wagers may be made within a given property and/or within a jurisdiction of a player club if the club spans multiple properties, for example. Wagers extending to other jurisdictions served by a progressive may be possible through cooperation with a wide area progressive provider, for example.

In certain embodiments, player statistics may be used as variables on which to place a wager. For example, a player may wager that the next jackpot exceeding $1000 will be won by a carded player whose last name begins with “S”. As another example, a player may wager that the next jackpot exceeding $500 will be won by an uncarded player.

In certain embodiments, floor or property statistics may be used as a basis for a wager. For example, a patron may wager that there will be more than 20 jackpots exceeding $100 on a casino floor within the next two hours. As another example, a user may wager that there will not be a jackpot exceeding $1000 on the casino floor in the next hour.

In certain embodiments, bets predicting combinations of slot machine events (for example, a maximum pay jackpot) may also be placed. For example, slot machines may be visualized as balls or numbers in a bingo, keno or lotto game. An occurrence of each specified slot machine event essentially equates to a ball being drawn for bingo, keno, or lotto, for example. For example, a user may “pick 6”, or specify that slot machines 3, 6, 12, 23, 30 and 34 will be the next six gaming machines to produce a predefined event (in any order). As another example, a user may select a “wheeled pick 6”, or selecting slot machines [(3/4/5), (10/12/13), (22/23), 31, 35, and 39] as the next six machines to produce a predefined event (in any order). As another example, a user may pick a perfecta, trifecta, and/or superfecta by picking, for example, 2, 3 or 4 gaming machines to produce a predefined event (in order). In certain embodiments, depending on a size of a casino or other gaming property, a “Pick 4”, “Pick 5”, or “Pick 6” game in which a player must accurately pick the next several gaming machines to generate a jackpot, for example, may have odds on the order of a lottery or large multi-site progressive. In certain embodiments, a player may place a parlay wager and place a plurality of wagers (e.g., 2 wagers, 3 wagers, 4 wagers, etc.) that all must come true in order to win. In certain embodiments, a subset of gaming terminals on a casino or other gaming property floor may be used for multi-pick wagering. In certain embodiments, gaming terminals used for multi-pick wagering may or may not be identified to a player depending upon property preference and jurisdictional requirements.

In certain embodiments, slot system wagering may be combined with other events as a way of adding value or excitement to such events. For example, Pick 3/4/6 may be provided as a system wager during a slot tournament. That is, gaming machines used in the slot tournament comprise the “field” from which to pick. Wagering may be limited to patrons participating in the tournament or offered to non-participating patrons as well. Similarly, a perfecta/trifecta/superfecta may be bet during a slot tournament but machines must be chosen in order. In a bus tour quinella, a field from which to choose consists of carded members of a bus tour rather than physical gaming machines. Wagers predict the next two players to win a significant, predetermined event on any machine on the gaming floor or within a pre-designated subset of gaming machines on the gaming floor, for example. In slot bingo, slot machines being played during a tournament, for example, are correlated with numbers found in a standard bingo game. Events generated by slot machine play drive numbers called for a bingo game. In such a situation, the generated events may be queued in order of generation and are presented to the bingo players at an appropriate pace, for example.

In certain embodiments, system dependent wagers may be provided in conjunction with tournament play. For example, Player A plays machine 123 but does not think that he is particularly lucky. He places a wager on the machine 456 played by Player B who Player A perceives to be “luckier”. Additionally, a player not participating in the tournament could bet on the players in the tournament in a manner akin to a horse race bet (e.g., win, place, show, exacta, quinella, etc.)

In certain embodiments, a gaming system allows a customer to determine a denomination of the gaming system on which the customer is playing. For example, a multi-denomination gaming machine may have a menu through which a player may select the machine's denomination from a range of options (e.g., 1 c, 2 c, 5 c, 25 c, 50 c, $1.00, etc.). Downloadable and/or server-based gaming may also provide multi-denominational opportunities.

In certain embodiments, system wagers may be placed with respect to multi-denominational gaming. For example, a player may wager that “Machine A will hit a 1000 credit jackpot within the next 24 hours.” In certain embodiments, to accommodate wagers in varying denominations, a wager may be based on a ratio between a total amount won at a gaming machine (e.g., all lines hit plus any bonuses resulting from the game play) and a total amount wagered for a given handle pull at the gaming machine (e.g., a win:wager ratio of 1000), for example. In another embodiment, win criteria for a wager may include specific symbol alignments (e.g., win criterion may include “a five scatter symbol win” or “five cherries on a line”), for example. In certain embodiments, a proposition may be scaled to accommodate a change in denomination (e.g., a switch from quarters to dimes).

In certain embodiments, relocation and/or conversion of one or more gaming machines may be accommodated in a proposition. For example, these situations may occur when a game cabinet is physically moved (e.g., to another location on the gaming floor, off the floor, etc.) and/or when software is changed to “convert” to a different game (EPROMS and glass are changed out to switch a game from “Double Dolphins®” to “Tiki Torch®”, for example). The physical game cabinet may or may not be moved as part of a conversion. One or more of the moved/converted machines may have active wagers associated with them.

In an embodiment, if a machine is moved and/or converted, applicable propositions may be invalidated and money returned to applicable player(s). Alternatively, manual and/or automatic substitutions may be allowed. For example, if the wager was on Machine A, and Machine A was taken off the floor but Machine B has identical characteristics, the wager could be shifted to Machine B and run to completion. As another alternative, machine moves and/or conversions may be pre-scheduled so as to not conflict with system-related propositions. For example, a slot director logs into a gaming control system and identifies EGM Bank A as being due for move/conversion/maintenance the following day. The system then prevents any conflicting wagers from being made.

Game and/or machine conversion may also include dynamic and/or downloadable game systems, for example. For example, a game title may be matched with its physical cabinet location. For example, Chameleon cabinet 10-10-5 might comprise Geishag®, Tiki Torch, Sun & Moon™, Double Dolphins®, and Queen of the Nile®. Separate accounting meters may be tracked for each individual game on that cabinet. That is, accounting for a 10-10-5-TikiTorch game is kept separate from 10-10-5-Geisha and is also kept separate from a 10-10-6-TikiTorch game (e.g., same game, different cabinet).

In addition to the above machine move/conversion options, the possibility of a “running total” may be applied. As an example, a wager is placed on a 10-10-5-Geisha game to have a win/wager ratio of 1000 over a 24 hour period. The wager may indicate a non-continuous period of 24 hours of accumulated time while Geisha is active on the machine. For example, when a Tiki Torch game is played on the machine, the clock stops on the Geisha wager. The clock for that wager then continues when Tiki Torch is swapped out and Geisha is swapped back in.

In certain embodiments, a machine or bank of machines may be disabled, shut down, and/or otherwise “out of order” (such as for periodic maintenance (refilling printer paper) or drops (collecting money and tickets from the machines)). In certain embodiments, a “clock” associated with proposition(s) related to the “down” machine may be stopped or “frozen” during the down time, for example. If the down time exceeds a certain amount, the wager may be cancelled and money returned, for example.

In certain embodiments, propositions may be based on amount of play instead of and/or in addition to a certain time period. System dependent wagers may be made and odds computed based on a number of plays of a gaming machine and/or group of gaming machines, for example.

In certain embodiments, a certain minimum amount of play may be included in a system wager. If the minimum amount of play is not met, for example, the wager might be cancelled and funds returned, or the time period of the wager may be extended until the minimum is met, for example. Thus, gaming environments may help protect against effects of anomalies and tampering on system wager propositions. For example, a casino may want to prevent a person from making a proposition that a machine will not hit in the next hour and then planting him or herself at that machine, reading a book for an hour.

In certain embodiments, a number of plays in a given time frame may be estimated based on a number of criteria: the theoretical “maximum play” per time period on a given machine may be known and/or may be determined based on max coin in and average time to complete a given play, for example. The “average play” per time period may also be estimated based on historical play of a device, for example. In certain embodiments, play estimates may be used to compute odds for wager propositions related to time and/or other criteria, for example.

The above features, as appropriate, may also be made available through an interface such as a kiosk 200 (e.g., a workstation, terminal, interactive display, etc.) located on the gaming floor or in another location, a wireless device 180 (such as a cellular phone, personal digital assistance, handheld and/or pocket computer, etc.), and/or a web-based interface external to the casino or other gaming location (e.g., a web browser on a home computer or television, an interface on a hotel computer or television, etc.). Players may be able to access applicable information and/or place bets while away from the casino floor (for example, in a hotel room or home). Using any of a variety of interfaces, a player may view a menu or other listing of options, select an option, place a wager, and generate a record, for example. An interface may also allow a player to learn about new wagers available at the casino or read reviews and information related to wagers prior to going to the casino, for example. The player may add interesting wagers, games, and/or other feature(s) to his or her list of “favorites” in a player profile for easy access while on the casino floor. Additionally, the kiosk 200, wireless device 180, or other interface device may provide players with a site map or other casino information. The kiosk, wireless device, or web-based interface may enable players to find out where games are on a gaming floor, jackpot information, and the like.

In an embodiment, the system 100 may be integrated and/or associated with a casino management system. The casino manager facilities player tracking, slot accounting, game configuration, and bonusing, for example, in the system 100. The casino manager, such as an OASIS™ casino management system, may also facilitate promotions, ticket generation, marketing, reporting, crediting, and communication between players, gaming employees, and the system 100, for example. The casino manager may be used for game configuration and modification for gaming terminals, for example. The casino manager helps to provide centralized management of a gaming environment, such as one or more casinos. Examples of gaming networks may be found in U.S. patent application Ser. No. 10/938,351 (filed Sep. 10, 2004), Ser. No. 10/938,103 (filed Sep. 10, 2004), and Ser. No. 10/935,514 (filed Sep. 7, 2004), which are herein incorporated by reference.

A management system may allow authorized users to configure games and/or progressive links/levels, including adding and removing games and/or progressive links/levels, meters, and/or setting jackpot reset amounts and rate of progression, for example. Reports, such as accounting, diagnostic and administrative reports, may also be generated. Information may be displayed at a remote terminal, gaming terminal display, overhead display, and/or other display, for example. One or more databases may be accessed to aid in report generation, game configuration, and/or other system adjustment, for example.

Additionally, a management system may facilitate player tracking, slot accounting, game configuration, and bonusing, for example, in a gaming environment. A gaming manager, such as an OASIS™ casino management system, may also facilitate promotions, ticket generation, marketing, reporting, crediting, and communication between players, gaming employees, and the system 100, for example. The gaming manager may be used for game configuration and modification for gaming terminals. The gaming management system helps to provide centralized management of a gaming environment, such as one or more casinos.

Certain embodiments may be implemented in software, firmware, and/or hardware, for example. For example, certain embodiments may be implemented as a set of instructions or routines stored on a machine-readable medium, such as a CD, DVD, CD-ROM, DVD-ROM, hard disk, floppy disk, RAM, ROM, flash memory, and/or other medium, for execution on a computer and/or other processing device. Certain embodiments may be implemented on a standalone gaming terminal, a bank of gaming terminals, a network of gaming terminals, and/or a client-server system communicating with one or more gaming terminals and/or other devices, for example.

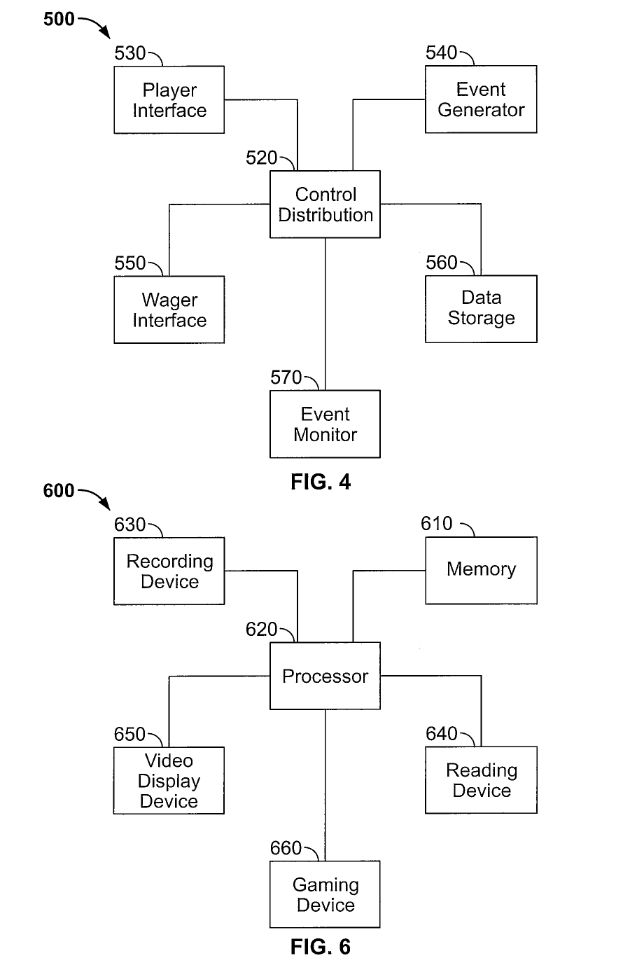

As an example, FIG. 4 illustrates a system 500 for placing and monitoring system wagers in accordance with an embodiment of the present invention. The system 500 includes a control distribution 520, a player interface 530, one or more event generators 540, a wager interface 550, a data storage 560, and an event monitor 570. A player, another patron, and/or authorized personnel may interact with the system 500 via the player interface 530. During normal game play, a player interacts with one or more event generators 540, such as games located at gaming terminals or other devices. The event generators 540 generate events during the course of play, between plays, overlapping multiple plays, and/or unrelated to play, for example. When a player decides to place a system wager, the control distribution 520 transfers the player to the wager interface 550.

The wager interface 550 allows the player to choose various events and then define one or more relationships between the events. The interface 550 displays odds and/or expected return to the player for a single unit of bet. The player may enter a wager via the interface 550, and the wager, related event(s), and relationship(s) may be stored in the data storage 560, for example.

The control distribution 520 returns the player to the standard player interface 530. The system begins to monitor events, such as by using the event monitor 550. Events are generated during normal game, between normal game play, and/or across normal game play, for example. As an event is generated, the event monitor 570 determines whether the event has been identified within a system wager.

If the event is not identified in a wager, the system continues to monitor events and play games. If an event is identified with a system wager, then the system checks the relationship between the event and any other events as defined by the wager. Checking the relationship(s) between the identified event and other event(s) allows the system to determine if the wager has been resolved.

If the wager has not been resolved, the system continues to monitor events. If a system wager has been resolved, then the system determines if the player won or the player lost and either pays the player or the system.

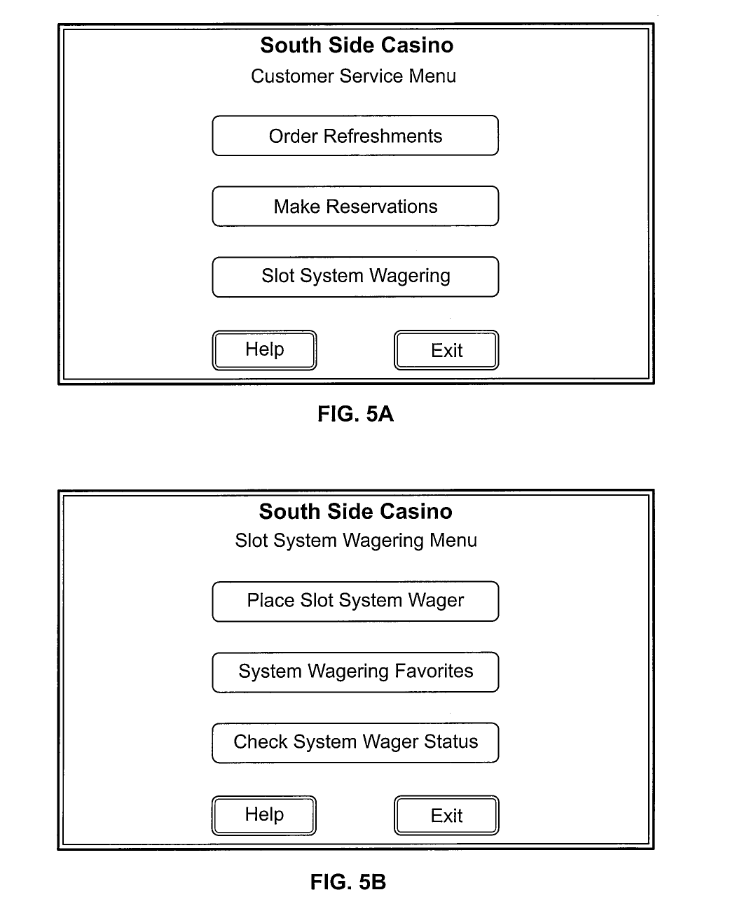

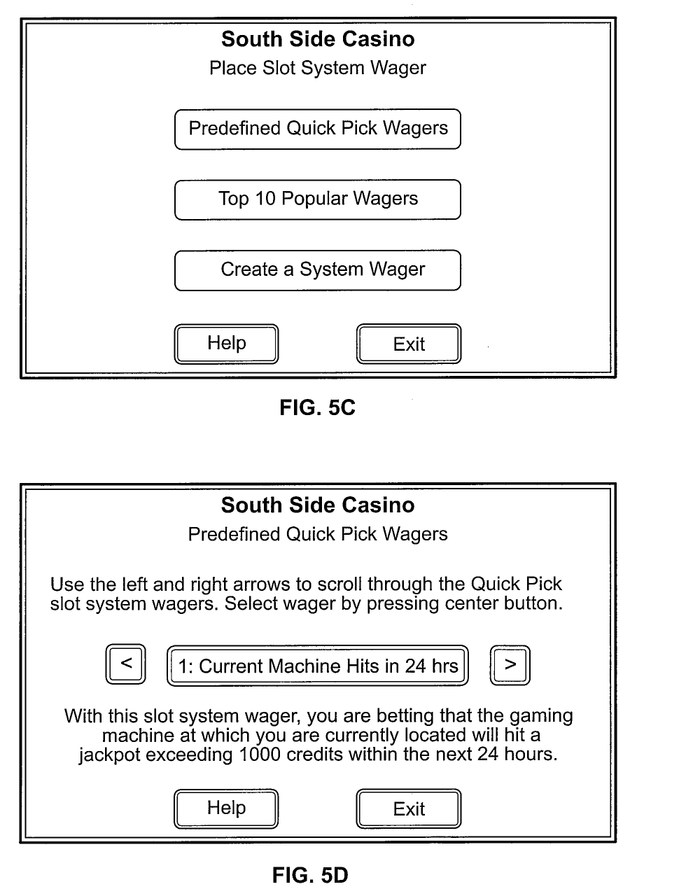

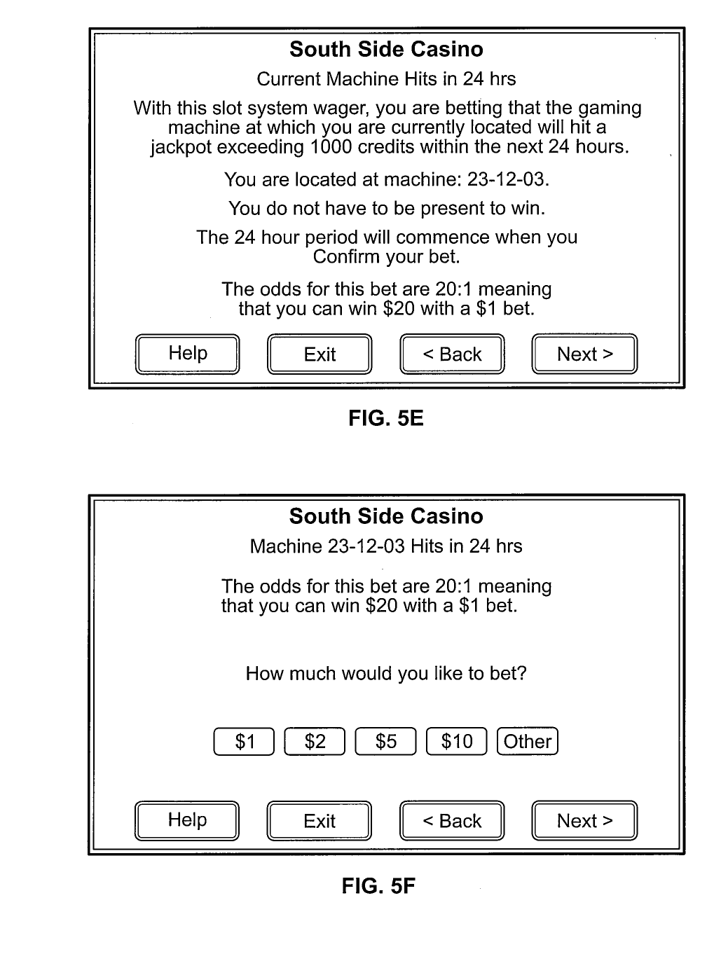

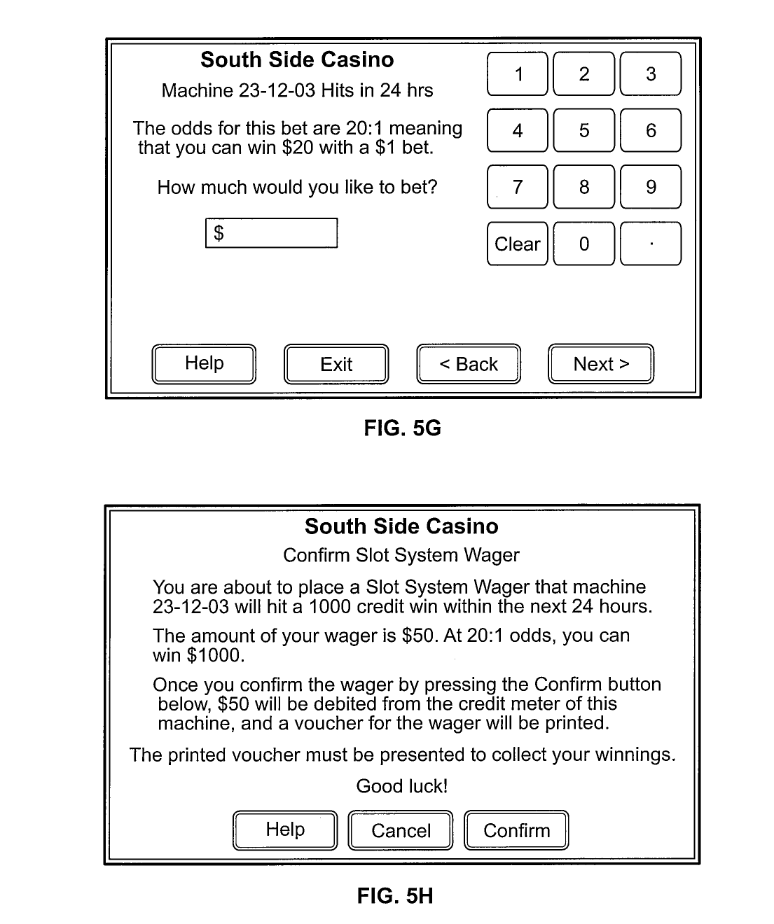

FIGS. 5a-5h illustrate a plurality of exemplary interfaces and menus for slot system wagering used in accordance with embodiments of the present invention. For example, as shown in FIG. 5a, a customer may be presented with a customer service menu allowing the customer to order refreshments (e.g., food, drink, etc.), make reservations (e.g., hotel, restaurant, theater, excursion, tour, etc.), place a slot system wagering, access help content, etc. Such as menu may be presented to a customer at a gaming terminal, a kiosk, a workstation, a wireless device, a computer terminal, etc.

If a customer selects the slot system wagering option, for example, a slot system wagering menu, such as the example shown in FIG. 5b, appears. The interface may allow a customer to place a slot system wager, view system wagering “favorites” (e.g., popular and/or preset wagering opportunities), check a status of an existing slot system wager, access help content, etc.

When a customer places a slot system wager, the customer may see an interface similar to the example shown in FIG. 5c. FIG. 5c illustrates menu buttons for predefined quick pick wagers, top 10 popular wagers, create a system wager, help and exit. Thus, a customer may select a predefined slot system wager, view and select popular wagers and/or create a slot system wager.

FIG. 5d shows an exemplary interface for selecting predefined slot system wagers. A customer may scroll or page through a list of predefined wagers and select a desired wager from the list. As shown, for example, in FIG. 5e, information regarding a wager may be viewed by the customer. As shown, for example, in FIGS. 5f and 5g, a customer may view odds for a wager and place a bet by selecting a preset amount and/or specifying a custom amount.

After a wager has been selected and a bet has been entered, the customer may see a screen asking the customer to confirm the slot system wager. As illustrated in FIG. 5h, for example, a summary of the wager may be displayed, and the customer may be given an option to ask for help, cancel the wager, and/or confirm the wager.

FIG. 6 depicts a system 600 for recording slot system wagers in accordance with an embodiment of the present invention. The system 600 includes a memory 610 arranged to store slot system wager records. The system 600 also includes a processor 620 in communication with said memory 610 designed or configured to store and retrieve slot system wager records. The system 600 further includes a recording device 630 directly or indirectly controlled by said processor 620. The processor 620 stores data pertaining to the wager in the memory 610 and instructs the recording device 630 to create a machine readable record of the wager for use by the patron placing the wager.

In certain embodiments, the machine readable record is recorded on one or more of an optically readable media, a magnetically readable medium, and/or an electronically readable medium, for example. In certain embodiments, the machine readable record is also human readable. For example, a ticket may be generated with a barcode or magnetic stripe and alphanumeric printing to allow both a machine and a human to read all or part of the record

In certain embodiments, the recording device 630 is implemented as one or more of a printer arranged to print paper scrip, a magnetic card embosser arranged to store data on the magnetic strip of a magnetic card, and/or an electronic interface arranged to connect with and write data to an electronic memory device, for example.

The system 600 may also include a reading device 640 that is directly or indirectly controlled by the processor 620 to read a machine readable record and communicate data in the machine readable record to the processor 620. Additionally, the system 600 may include a video display device 650 that is directly or indirectly controlled by the processor 620 to display a status of the wager associated with the machine readable record.

In certain embodiments, the video display device 650 displays a status message for a wager still in effect, and the reading device 640 returns the machine readable record to the patron. If the wager is no longer in effect, the reading device 640 may retain or rest the machine readable record. If the wager is a loss, the video display device 650 may display a message informing the patron of the loss. Conversely, if the wager is a win, the video display device 650 may display a message informing the patron of the win.

In certain embodiments, the system 600 may also include an associated gaming device 660. If the wager is a win, for example, the processor 620 may instruct the video display device 650 to display a message enabling the patron to execute at least one of the following options: 1) transfer win proceeds to a credit meter of the associated gaming device 660, 2) print a voucher bearing the value of the win proceeds, and/or 3) transfer win proceeds to a system-based electronic fund account associated with the patron, for example.

For example, a gaming device may generate a ticket including a record of a slot system wager. The player may check the status of a wager by inserting the previously generated ticket into the gaming device. Upon insertion, the gaming device performs a loolup and returns a status (and the ticket) if the wager is still open. If the wager has completed, the gaming device retains the ticket and offers payment through a variety of methods (e.g., issuing a voucher, providing credits on the gaming device, transferring payment to an online account (e.g., Personal Banker), etc.).

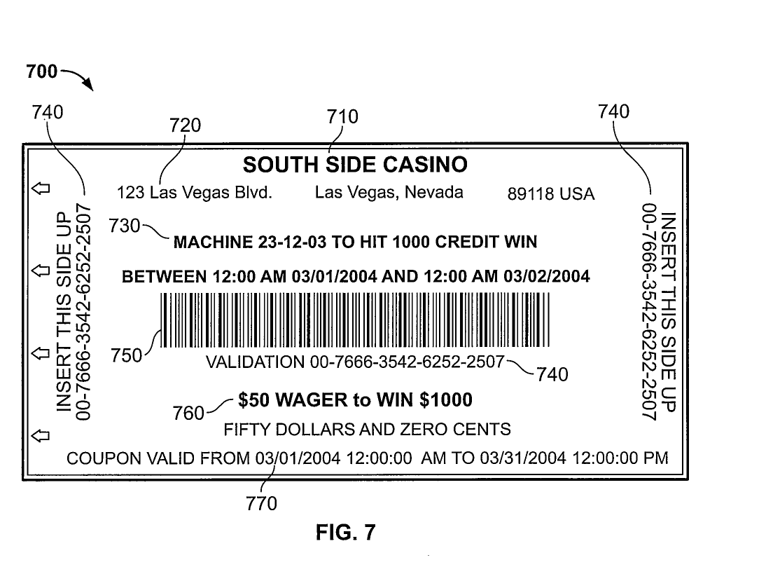

Referring now to FIG. 7, Slot System Wagering Scrip 700 comprises casino name 710, casino address 720, wager description 730, human readable unique identifier 740, machine readable unique identifier 750, wager amount 760, and expiration 770. The scrip or ticket 700 may be used in conjunction with slot system wagering described above to verify a player's wager and/or provide additional information. FIG. 7 illustrates one exemplary embodiment of such a ticket. As shown in FIG. 7, casino name 710 and casino address 720 identify the casino or other gaming establishment at which the slot system wager is based. The wager description 730 provides details of the slot system wager made. The human readable unique identifier 740 provides an identifier, such as a number, that may be read and understood by a human to identify and/or validate a scrip 700 and/or associated slot system wager. The machine readable unique identifier 750 provides similar and/or corresponding information to a gaming device, kiosk and/or other system electrically reading the scrip 700. Other information, such as a wager amount 760 and/or expiration 770 of the slot system wager, may be found on the scrip 700. In certain embodiments, a coupon, advertisement and/or other promotion may be printed and/or otherwise listed on the scrip 700.

Thus, certain embodiments provide systems and methods allowing wagers to be placed based on one or more events and/or event combinations related to gaming system play and/or other activity. Certain embodiments allow wagers based on events occurring during game play, apart from game play, and/or in relation to performance and/or activity related to one or more gaming terminals, banks, properties, and/or other combination, for example. System dependent or “side” bets may be placed at a gaming machine and/or via a separate interface, for example. Thus, both gaming machine players and non-players may participate. The examples given above are for illustration only and are not intended to limit the scope of embodiments. Certain embodiments are implemented as wagers “against the house”, but, in certain embodiments, pari-mutuel wagering may be used.

While the invention has been described with reference to one or more preferred embodiments, those skilled in the art will understand that changes may be made and equivalents may be substituted without departing from the scope of the invention. In addition, many modifications may be made to adapt a particular step, structure, or material to the teachings of the invention without departing from its scope. Therefore, it is intended that the invention not be limited to the particular embodiment disclosed, but that the invention will include all embodiments falling within the scope of the appended claims.

What is claimed is:

1. A method for wagering in a system including a plurality of gaming devices each adapted to receive a game wager to play the device to produce a winning or losing game result for the game wager, said method comprising:
allowing a player place a system wager on a system defined proposition and in addition to any game wager;
monitoring the performance of the play of said gaming device; and
awarding a prize based on said system wager upon occurrence of said proposition.

2. The method of claim 1, wherein said system wager is placed in addition to a main game wager placed for play by the player at the gaming device.

3. The method of claim 1, wherein said step of allowing further comprises allowing the player to place a system wager on a proposition related to a future event occurring subsequent to the next play of the gaming device.

4. The method of claim 1, further comprising inputting player identification information at said gaming system.

5. The method of claim 1, wherein said prize is awarded based on performance of a plurality of gaming devices including said gaming device.

6. The method of claim 1, wherein said step of allowing further comprises allowing a player to place a system wager remotely from said gaming device.

7. The method of claim 1, wherein said system wager is deducted from an account.

8. The method of claim 1, wherein said system wager is deducted from credit available for game play at said gaming device.

9. The method of claim 1, wherein said performance of said gaming device is monitored using a slot accounting system.

10. A dependent wagering system, said system comprising:
an interface converting an input of a wager into a wager record, wherein input of the wager includes selecting at least one system event and selecting a relationship for said at least one system event to form a proposition;
an event monitor configured to monitor system events occurring in one or more gaming devices, wherein said event monitor identifies a system event relating to said wager record; and
an event handler configured to examine said wager record and said identified system event to determine if said proposition is satisfied.

11. The dependent wagering system of claim 10, wherein said interface allows a player to select a proposition from a list.

12. The dependent wagering system of claim 10, wherein said interface allows a player to configure a proposition for approval.

13. The dependent wagering system of claim 10, wherein odds are calculated for a proposition based on at least one of a time period and a theoretical number of plays.

14. The dependent wagering system of claim 10, wherein said wager is placed in addition to a game wager placed for play by the player at a gaming device.

15. The dependent wagering system of claim 10, wherein said wager is placed on a proposition related to a future event occurring subsequent to the next play of a gaming device.

16. The dependent wagering system of claim 10, wherein a prize is awarded based on performance of a plurality of gaming devices.

17. The dependent wagering system of claim 10, wherein said interface allows a player to place a system wager remotely.

18. A machine-readable medium including a set of instructions capable of execution by a processing device, said set of instructions comprising:
a wager configuration routine for constructing a proposition based on one or more gaming events and one or more relationships for said one or more gaming events, wherein a user is allowed to place a wager in relation to said proposition;
a monitoring routine for monitoring gaming events occurring in a gaming environment; and
a wager management routine for determining resolution of said wager based on a comparison of one or more gaming events detected by said monitoring routine and said one or more gaming events and relationships associated with said wager.

19. The set of instructions of claim 18, wherein said wager configuration routine associates fixed odds with said proposition.

20. The set of instructions of claim 18, wherein said wager configuration routine associates pari-mutuel odds with said proposition.

21. The set of instructions of claim 18, wherein said wager configuration routine allows a user to construct said proposition based on at least one of selecting one or more propositions from a list and assembling one or more propositions based on a combination of one or more gaming events and one or more relationships.

22. The set of instructions of claim 18, wherein said monitoring routine comprises a slot system accounting routine.

23. The set of instructions of claim 18, wherein said wager comprises at least one of a wager that said proposition will occur and a wager that said proposition will not occur.

24. The set of instructions of claim 23, wherein said proposition includes at least one of a time period and a number of plays.

25. An apparatus for recording slot system wagers comprising: a memory arranged to store slot system wager records;
a processor in communication with said memory, said processor configured to store and retrieve slot system wager records; and
a recording device directly or indirectly controlled by said processor;
wherein said processor stores data pertaining to a slot system wager in said memory and instructs said recording device to create a machine readable record of said slot system wager for use by a patron placing said slot system wager.

26. The apparatus of claim 25 wherein said machine readable record is also human readable.

27. The apparatus of claim 25 wherein said machine readable record is recorded on at least one of an optically readable media, a magnetically readable media, and an electronically readable media.

28. The apparatus of claim 25 wherein said recording device comprises at least one of a printer arranged to print paper scrip, a magnetic card embosser arranged to store data on a magnetic strip of a magnetic card, and an electronic interface arranged to connect with and write data to an electronic memory device.

29. The apparatus of claim 25, further comprising a reading device, which is directly or indirectly controlled by said processor wherein said reading device reads a machine readable record and communicates data contained in the machine readable record to the processor.

30. The apparatus of claim 29, further comprising a video display device which is directly or indirectly controlled by said processor, wherein said processor displays the status of the wager associated with said machine readable record on said video display device.

31. The apparatus of claim 30, wherein if said wager is in effect, said processor instructs said video display device to display an appropriate status message and instructs said reading device to return said machine readable record to the patron.

32. The apparatus of claim 30, wherein if said wager is not in effect, said processor instructs said reading device to retain or reset said machine readable record.

33. The apparatus of claim 32, wherein if said wager is a loss, said processor instructs said video display device to display a message informing said patron of the loss.

34. The apparatus of claim 32, farther comprising an associated gaming device, wherein if said wager is a win, said processor instructs said video display device to display a message enabling said patron to direct at one of the following actions to be taken: transfer win proceeds to a credit meter of the associated gaming device, print a voucher bearing a value of the win proceeds, and transfer win proceeds to a system-based electronic fund account associated with said patron.
